(19) United States
(12) Patent Application Publication
(10) Pub. No.: US 2004/0010351 A1
(43) Pub. Date: Jan. 15, 2004

(54) Method and system for information handling system component mounting with vibration dampening

(76) Inventors: Ahmed Mohiuddin, Austin, TX (US); James Don Curlee, Round Rock, TX (US)

Correspondence Address: HAMILTON & TERRILE, LLP, P.O. BOX 203518, AUSTIN, TX, 78720, US

(21) Appl. No.: 10/194,381

(22) Filed: Jul. 12, 2002

(51) Int. Cl. G05B 13/00

(52) U.S. Cl. 700/300; 361/695

(57) ABSTRACT

A method and system are provided which substantially reduce the disadvantages and problems associated with previous methods and systems for dampening vibration noise of a system component. Two shot injection molding of the component housing support integrates rigid and dampening portions that install the component in the system with vibration dampening.

### RELATED APPLICATIONS

This application generally relates to U.S. patent application Ser. No. 10/152,594, entitled “Method and System for Vibration Dampening,” filed on May 21, 2002 and having a common inventor and assignee.

### BACKGROUND OF THE INVENTION

1. Field of the Invention

The present invention relates in general to the field of dampening vibrations, and more particularly to a method and system for information handling system component mounting with vibration dampening.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems having played an important role in improving worker and individual productivity by automating tasks and performing complex computations. For instance, information handling systems commonly perform day-today operations in banks, libraries, research facilities, homes and other locations where workers and individuals spend significant amounts of time in quiet thought to accomplish complex tasks. Information handling systems assist by quietly tracking financial transactions and inventory, by acting as word processors that record research results or by connecting to networks to transfer valuable information on a timely basis. Under a number of circumstances in which information handling systems operate, quiet operation is an important consideration for users.

One difficulty with keeping information handling system operations as quiet as possible is that the electronic components that perform or support information handling tend to generate heat that typically must be removed by cooling fans in order to ensure proper operation. Cooling fans often represent the greatest noise producing component of an information handling system. As information handling systems have grown more powerful with greater power consumption and faster operating speeds, the need for cooling has increased, leading to the use of more powerful cooling fans that operate at higher speeds and for greater time periods. To reduce the vibration and related noise of cooling fans, cooling fans are typically installed into information handling systems with vibration dampers, such as elastic washers or grommets that absorb vibrations. However, these vibration dampening pieces increase the complexity of manufacturing information handling systems since they are often small pieces that are manually installed with cooling fans.

### SUMMARY OF THE INVENTION

Therefore a need has arisen for a method and system which mounts information handling system components with a housing having integrated vibration dampening to decrease system noise.

A further need exists for a method and system which incorporates vibration dampening for a system component without substantially increasing the complexity of assembling the component in an information handling system.

A further need exists for a cooling fan housing with integrated dampening proximate the mount of the cooling fan housing to the chassis of an information handling system to reduce noise associated with cooling fan operation.

In accordance with the present invention, a method and system are provided which substantially reduce the disadvantages and problems associated with previous methods and systems for dampening vibration noise of a system component. Two shot injection molding of the component housing support integrates rigid and dampening portions that install the component in the system with vibration dampening.

More specifically, an information handling system cooling fan housing is molded as a single piece that includes a dampening portion to dampen vibrations generated through cooling fan operation and a rigid portion for supporting the cooling fan. The cooling fan housing defines a cooling air channel for the cooling fan to pass cooling air through in order to cool heat-generating components of the information handling system. The cooling fan housing mounting point to the information handling system integrates a dampening material to couple the housing to the information handling system and dampen vibration noise from cooling fan operations. The cooling fan housing has a rigid portion formed by a substantially rigid material that defines the cooling air channel and provides support to secure the cooling fan, and has a dampening portion formed by a vibration-absorbing material that attaches to the information handling system or is proximate an attachment device to absorb vibration transferred from the cooling through the housing. A cooling fan couples to the cooling fan housing and the cooling fan housing couples to an information handling system to align cooling air flow to remove heat from heat-generating components.

In one embodiment, the cooling fan housing is formed as a single, integrated piece with a two shot plastic injection. A substantially rigid plastic is injected in one shot to form the cooling fan housing so that it supports a cooling fan and defines a cooling air channel. An elastic plastic is injected in another shot to form the dampening portion of the cooling fan housing mounting point. For instance, the elastic material is injected into a tool during formation of the cooling fan housing to form an attachment device that couples to an attachment point of the information handling system. The attachment point is formed as a male member having an attachment ring to secure the housing to the information handling system. For instance, a nipple at the end of the male attachment member pulls through a female opening of the information handling system housing with the attachment ring flexing to fit through the opening and then expanding to hold the male member secure. The two shot injection molding process produces a single fan housing assembly piece with the vibration-absorbing elastic portion of the cooling fan housing mounting point integrated with the rigid portion of the cooling fan housing. Thus, assembly of the information handling system involves coupling the cooling fan housing mounting point attachment device to the information handling system without separate vibration absorbing grommets or pieces.

The present invention provides a number of important technical advantages. One example of an important technical advantage is that vibration dampening provided for a component decreases the noise associated with operation of the component. For instance, a cooling fan operates in an information handling system with vibrations isolated by an elastomer vibration dampening portion of the cooling fan housing proximate the mounting point of the housing to the information handling system, while a rigid portion of the cooling fan housing holds the fan securely in position. The information handling system operates quietly, providing an environment more conducive to concentration by information handling system users.

Another example of an important technical advantage of the present invention is that information handling system assembly is simplified. For instance, the use of two shot plastic injection to form a single integrated component housing piece having a rigid support portion and an elastic attachment portion provides reduced assembly steps for installing a component into an information handling system with vibration dampening. The integrated vibration dampening section of the component housing eliminates or reduces the need for assembling additional vibration absorbing grommets or other devices, thus reducing manual labor and costs associated with information handling system assembly. Moreover, a component housing with integrated dampening reduces design complexity by solving vibration dampening at the component housing instead of at the design of the information handling system housing. Thus, separate vibration isolation is not required for separate information handling system housing chassis since the isolation material is incorporated in the component housing.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a side view of a block diagram of an information handling system;

FIG. 2 depicts a side cutaway view of a cooling fan housing mounted to an information handling system with supports having integrated dampeners;

FIG. 3a depicts a side cutaway view of an information handling system elastic mounting point integrated with a rigid housing mounting support;

FIG. 3b depicts a side cutaway view of an information handling system elastic screw attachment device; and

FIG. 3c depicts a side cutaway view of an information handling system rigid mounting point proximate an integrated dampening section.

### DETAILED DESCRIPTION

Information handling systems are often used in noise-sensitive environments so that quiet operation is an important design consideration. The use of a cooling fan assembly, with integrated vibration dampening, aids in reducing the noise and vibration put out by an information handling system. For purposes of this application, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

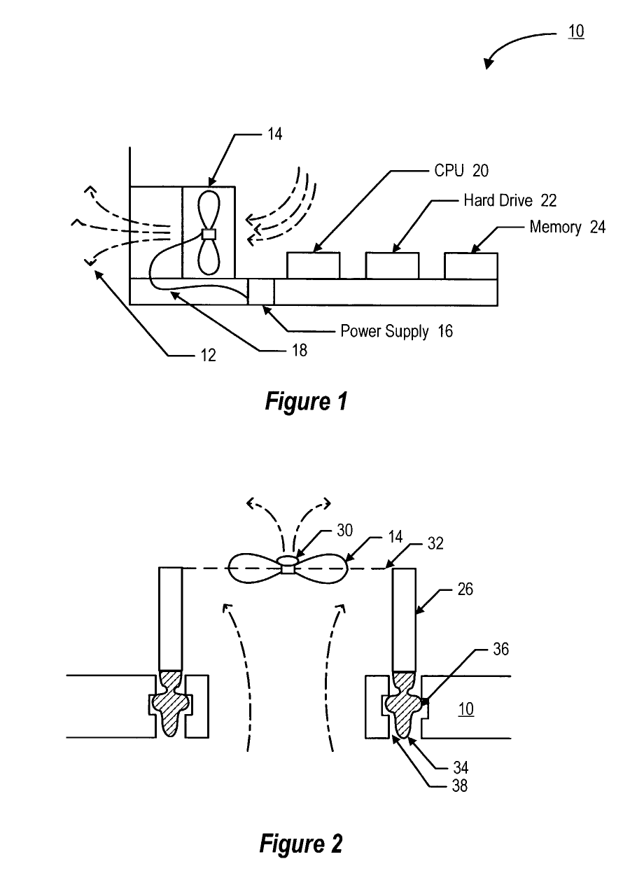

Referring now to FIG. 1, a side cutaway view of information handling system 10 is depicted with a cooling air flow provided by a cooling fan 14. Information handling system 10 includes electronic components that generate heat. If heat-generating components are not cooled, such as with a cooling air flow, failure of the heat-generating or other heat sensitive components may occur. One primary source of heat generation is a power supply 16, which typically accepts external AC power and transforms the AC power into DC power of predetermined voltages for use by information handling system electronic components. Power supply 16 provides power to cooling fan 14 through a power line 18. Another primary heat generating component is a CPU 20 which performs computations to support information handling functions. Typically, the faster a CPU operates, the more heat it generates and the more specialized and critical the transfer of heat from the CPU becomes. Thus, powerful CPUs generally depend on strong cooling air flow for proper operation. Other heat-generation components depicted in information handling system 10 include a hard drive 22 and memory 24. In other embodiments, a variety of electronic components may be included that also generate heat, such as system control and graphics processors.

Referring now to FIG. 2, a side cutaway view of a cooling fan assembly is depicted with integrated vibration dampening. A cooling fan housing 26 defines a cooling air channel 28 through which cooling fan 14 draws or pushes a cooling air flow. Power line 18 provides power to operate cooling fan 14 through a controller 30. Controller 30 varies cooling fan operation to adjust the strength of the cooling air flow as needed to maintain a predetermined temperature range within information handling system 10. Cooling fan 14 and controller 30 are mounted to a cooling fan mount 32 so that cooling fan 14 is held disposed in cooling air channel 28 by support members of mount 32. Cooling fan 14 couples to cooling fan mount 32 which couples to cooling fan housing 26 to firmly support cooling fan 14 within cooling air channel 28, resulting in the transmission of vibration during operation of cooling fan 14 to housing 26. In alternative embodiments, cooling fan 14 couples to housing 26 with a variety of attachment configurations so that some vibrations produced by operation of cooling fan 14 are transferred to housing 26.

Cooling fan housing 26 couples to information handling system 10 with one or more mounting points 34 that are integrated with cooling fan housing 26. Thus, during assembly of an information handling system, cooling fan 14 and cooling fan housing 26 are assembled into a cooling fan assembly and installed in information handling system 10 as a unit for ease of handling. A mounting point 34 of housing 26 has an attachment device 36 that secures housing 26 to openings 38 formed in the housing wall of information handling system 10. Mounting point 34 is manufactured with a dampening material, such as an elastomer or other flexible material, that is integrated with a generally rigid material that forms the rest of housing 26. Mounting point 34 forms attachment device 36 which secures housing 26 to information handling system 10.

In one embodiment, mounting points 34 are integrated with cooling fan housing 26 as a single piece by forming the piece with two shot plastic injection. One shot of the two shot plastic injection forms cooling fan housing 26 with a substantially rigid material to support the weight and operation of cooling fan 14 and to define air channel 28. Another shot of the two shot plastic injection forms mounting points 34 integrated with housing 26 with the mounting points formed from an elastic material that absorbs vibrations associated with operation of cooling fan 14. The two shot plastic injection integrates the rigid and elastic portions of housing 26 and mounting point 34 into a single piece that both firmly couples cooling fan housing 26 to information handling system 10 and absorbs vibrations from cooling fan 14 coupled to cooling fan mount 32. In alternative embodiments, additional dampening portions may be included at various positions of the cooling fan housing proximate the mounting point to provide dampening as needed. Further, two shot injection with rigid and elastic material may form supports with integrated dampening for a variety of applications beyond cooling fan dampening by forming housings for vibration-producing components to couple to information handling system 10 with integrated mounts of dampening material. Some examples of plastic materials for the formation of the rigid and flexible portions of housing 26 include: Polyone Synprene IT37-031 and APA Alcryn 2060 BK.

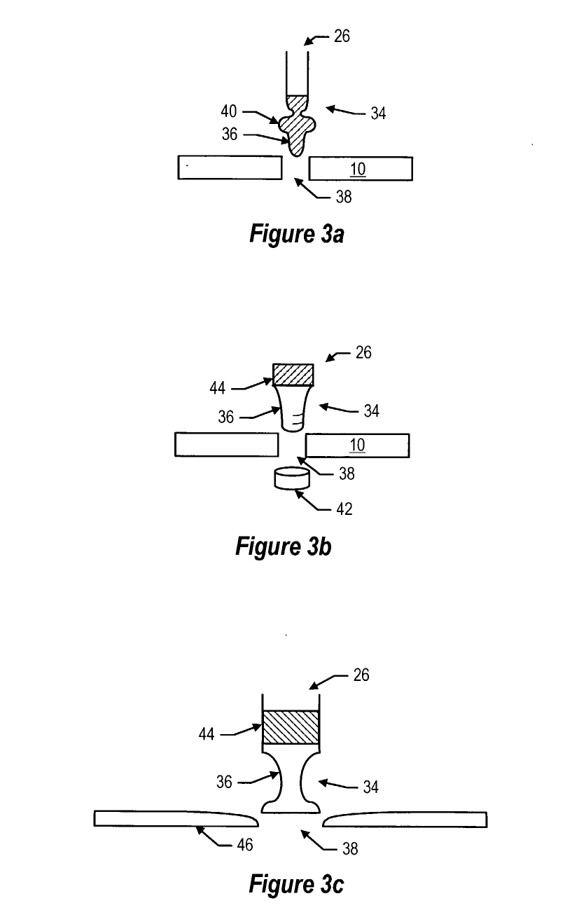

Referring now to FIGS. 3a, 3b, and 3c, a blow-up side view of an assembly of a fan housing 26 to an information handling system 10 illustrates the reduced complexity for information handling system assembly provided by dampening material integrated at the mounting point 34 of housing 26. The cooling fan assembly supported by housing 26 couples to an opening 38 of information handling system 10 in essentially a single step. FIG. 3a depicts an attachment point 36 formed as a male member that is inserted into a female opening 38 of information handling system 10. Attachment point 36 has a nipple shape and a securing ring 40 having a diameter that slightly exceeds the diameter of opening 38. The nipple end of attachment point 36 is pulled through opening 38, such as with pliers, to force securing ring 40 through opening 38, thus securing housing 26 to information handling system 10. Attachment point 36 is formed with an elastic material to absorb vibration and also to provide for flexibility of ring 40 to pass through opening 38.

FIGS. 3b and 3c depict alternative attachment points 36 and alternative locations for the dampening material proximate the mounting point 34. FIG. 3b depicts a screw attachment point 36 which is held in place by a nut 42. Screw attachment point 36 is formed with rigid material and a dampening section 44 is disposed between screw attachment point 36 and housing 26 so that dampening material secures housing 26 to information handling system 10. FIG. 3c depicts an indented attachment point 36 that engages flexible snaps 46 associated with information handling system 10. A dampening section 44 dampens vibration transfer from housing 26, although indented attachment point 36 may also be formed from dampening material. FIGS. 3b and 3c illustrate that a variety of attachment points may be used to secure housing 26 to information handling system 10 with the attachment points formed from flexible material or proximate flexible material to dampen vibrations.

With vibration dampening for cooling fan 14 provided by dampening portions of mounting points 34 integrated with housing 26, the need to couple cooling fan housing 26 to information handling system 10 with separate vibration dampening devices, such as elastic rubber grommets, is substantially reduced or eliminated. Thus, the assembly process for installing a cooling fan assembly into an information handling system 10 involves a reduced number of steps, reducing labor costs and part inventory management needs. Further, the use of two-shot molding to form a component housing places the vibration dampening in a single part tool to reduce the complexity of designing information handling system housing chassis component mounting. This results in reduced lead time and cost of vibration dampening solutions with vibration isolation located in the component housing, not the information handling system housing chassis.

Although the present invention has been described in detail, it should be understood that various changes, substitutions and alterations can be made hereto without departing from the spirit and scope of the invention as defined by the appended claims.

What is claimed is:

1. An information handling system cooling fan assembly comprising:
a housing forming a cooling air channel operable to direct a cooling air flow proximate to heat generating components, the housing having one or more mounting points operable to couple the housing to the information handling system; and
a cooling fan coupled to the housing and disposed in the cooling air channel aligned to force air through the channel to cool heat generating components;
wherein the housing comprises a generally rigid material and a dampening material, the dampening material integrated with the rigid material and associated with the one or more mount points, the dampening material operable to absorb vibrations created by cooling fan operation.

2. The information handling system cooling fan assembly of claim 1 wherein the mounting point dampening material comprises an elastomer operable to dampen vibrations.

3. The information handling system cooling fan assembly of claim 1 wherein the housing is molded by two shot injection molding with the housing molded in a first shot with a substantially rigid plastic and the one or more mounting points molded in a second shot with a substantially elastic plastic, the two shot injection molding forming a single integrated housing.

4. The information handling system cooling fan assembly of claim 1 wherein the one or more mounting points comprise flexible male members operable to securely insert in female attachment openings to couple the housing to the information handling system.

5. The information handling system cooling fan assembly of claim 4 wherein the flexible male member comprises a nipple having a flexible ring that locks into the female attachment opening.

6. The information handling system cooling fan assembly of claim 1 wherein the dampening material is disposed proximate to the mounting points, the mounting points comprising the generally rigid material.

7. The information handling system cooling fan assembly of claim 6 wherein the mounting points comprise snap attachment devices.

8. A method for manufacturing an information handling system cooling fan assembly, the method comprising:
performing two shot injection molding with first and second materials injected by first and second shots wherein:
the first shot inject molding with the first material forms a housing defining a cooling channel, the housing operable to align to a cooling fan to direct cooling air flow through the cooling channel to cool heat generating components; and
the second shot injection molding with the second material forms a dampening section integrated with the housing proximate mounting points operable to mount the housing to the information handling system.

9. The method of claim 8 wherein the first material comprises a substantially rigid plastic and the second material comprises a substantially elastic plastic.

10. The method of claim 8 further comprising:
coupling a cooling fan to the housing, the cooling fan disposed in the cooling channel.

11. The method of claim 10 further comprising:
coupling the housing to an information handling system to direct cooling air flow through the information handling system cool components of the information handling system.

12. The method of claim 11 further comprising:
powering the fan to flow air through the information handling system.

13. The method of claim 8 wherein the second shot injection molding is performed before the first shot injection molding.

14. An information handling system comprising:
a component housing operable to contain information handling system components;
plural components disposed in the component housing to perform information handling functions, the components generating heat;
a fan housing coupled to the component housing, the fan housing having a cooling channel aligned to direct cooling air flow through the component housing to cool the components, the fan housing having a rigid portion to support a fan and an elastic portion to dampen vibrations associated with the fan, the elastic portion integrated with the fan housing proximate the position that the fan housing couples to the component housing; and
a fan coupled to the fan housing and operable to generate cooling air flow through the cooling channel.

15. The information handling system of claim 14 wherein the fan housing rigid portion comprises a rigid plastic and the fan housing elastic portion comprises an elastic plastic.

16. The information handling system of claim 14 wherein the fan housing is formed by two shot injection molding to comprise an integrated plastic housing having the rigid and elastic plastics coupled together.

17. The information handling system of claim 16 wherein the elastic portion comprises an attachment device to couple the fan housing to the component housing.

18. The information handling system of claim 17 wherein the attachment device comprises a male fitting having a securing ring, the male fitting and securing ring insertable into an opening associated with the component housing, the securing ring having a diameter greater than the opening diameter and comprising a flexible configuration force through the opening and secure the fan housing to the component housing.

19. The information handling system of claim 16 wherein the rigid portion comprises the air channel and an attachment device and the elastic portion is disposed between the air channel and the attachment device.

20. The information handling system of claim 19 wherein the attachment device comprises a screw.

21. A method for dampening vibrations of a component installed in an information handling system, the method comprising:
two shot injection molding a component housing as a first rigid portion integrated with a second dampening portion, the component housing operable to support the component; and
coupling the component housing to the information handling system with the dampening portion.

22. The method of claim 21 wherein the component comprises a cooling fan.

23. The method of claim 21 wherein the dampening portion comprises an elastomer formed as an attachment device.

24. The method of claim 22 further comprising:
injection molding the component housing to define a cooling air channel with a substantially rigid plastic.
